(19) United States
(12) Patent Application Publication
(10) Pub. No.: US 2018/0123300 A1
(43) Pub. Date: May 3, 2018

(54) ELECTRONIC CONTROLLER

(71) Applicant: Robert Bosch GmbH, Stuttgart (DE)

(72) Inventors: Jan Hansen, Renningen (DE); Martin Rojahn, Tuebingen (DE); Matthias Ludwig, Moessingen (DE); Michael Hortig, Eningen U. A. (DE); Thomas Schrimpf, Reutlingen (DE); Stefan Rehm, Laichingen (DE)

(21) Appl. No.: 15/565,415

(22) PCT Filed: Mar. 23, 2016
(86) PCT No.: PCT/EP2016/056393

§ 371 Date: Oct. 9, 2017

(30) Foreign Application Priority Data
Apr. 10, 2015 (DE) 10 2015 206 481.6

(51) Int. Cl. H01R 24/50; H01R 24/44; H01R 24/52; H01R 24/76

(52) U.S. Cl. CPC H01R 24/50; H01R 24/76; H01R 24/52; H01R 24/44

(57) ABSTRACT

The invention relates to an electronic controller (10), having a housing (11), which is preferably made of plastic, having at least one high-frequency connection (14, 15), wherein the high-frequency connection (14, 15) has at least two elements (18; 18a; 18b; 18d, 20; 20a; 20b; 20c; 20d) that form a high-frequency conductor (19), for transmitting a high-frequency signal, and a screening element (21), wherein the two elements (18; 18a; 18b; 18d, 20; 20a; 20b; 20c; 20d) of the high-frequency connection (14, 15) are connectable to a circuit carrier (25) in the interior of the housing (11), and wherein the two elements (18; 18a; 18b; 18d, 20; 20a; 20b; 20c; 20d) of the high-frequency connection (14, 15) are formed on the side facing the circuit carrier (25) in the form of press-in pins (28; 28b; 28d, 29; 29b; 29c; 29d, 51).

### BACKGROUND OF THE INVENTION

The invention relates to an electronic controller. In addition, the invention relates to the use of a controller according to the invention.

DE 198 51 455 A1 by the applicant discloses an electronic controller which is a component of a drive unit operated by an electric motor in a motor vehicle, for example a drive unit in the form of a window lifter drive. The known electronic controller is distinguished by the fact that plug connections which are surrounded by a plug connection body are provided for forming electrical contact for components in the interior of the controller. This is done by partially encapsulating the plug connections by means of the material of the plug connection body which as a result forms what is referred to as a pre-mold. The plug connection body which is provided in this respect with the plug connections can either be inserted into a corresponding receptacle of a housing or else connected directly to the housing by encapsulation of the plug connection body by the material of the housing.

In technical aeronautical or shipping civil and military applications it is known to use, for the purpose of navigation, i.e. for determining the location of a vehicle, not only satellite-assisted information but additionally internal measuring devices in the form of magnet field sensors, inertia sensors or the like. Such a combination of satellite-assisted navigation with measuring devices arranged in the vehicle increases the accuracy of determination of positions and in many areas of the world is the only way of ensuring said determination. In this context it is often necessary to conduct the signals of a high-frequency antenna cable or other measuring devices into the interior of an electronic controller via a watertight or medium-tight connection. Owing to the relatively small quantities involved, in the prior art HF (high-frequency) sockets, screwed, for example, to the housing of the controller, are used for this purpose for the high-frequency signals by employing sealing rings or similar elements. Furthermore, the electrical contact is made with the sockets in a relatively costly fashion via cable connections or the like in the interior of the housing with a circuit carrier. The objective of such a connection between a socket and the circuit carrier is, on the one hand, to protect or screen the high-frequency signal (useful signal) from external interference influences and, on the other hand, to carry out impedance-controlled guidance regulation of the useful signal in the relevant frequency range. The feeding of the high-frequency signal which is described in this respect into the interior of the housing and within the interior of the housing is to be considered disadvantageous for large-scale technology such as is used, in particular, in motor vehicles, for reasons of fabrication and costs.

### SUMMARY OF THE INVENTION

With the prior art mentioned at the beginning as a starting point, the invention is based on the object of developing an electronic control unit in such a way that an arrangement which is optimized with respect to the transmission of the high-frequency signal is achieved with simple and cost-effective manufacture. In particular, as a result of a suitable geometry and selection of material for the elements of the high-frequency plug-type connection the characteristic impedance (impedance) along the transmission path of the high-frequency connection is to remain as constant as possible, i.e. to change as little possible. At the same time, a particularly simple and favorable connection, in terms of fabrication technology of the high-frequency connection to a circuit carrier, in particular in the form of a circuit board, is to be achieved.

This object is achieved according to the invention in an electronic controller essentially by virtue of the fact that the high-frequency connection has at least two elements, a high-frequency conductor for transmitting a high-frequency signal, and a springing element, wherein the two elements of the high-frequency connection can be connected to a circuit carrier (circuit board) in the interior of the housing, and wherein the two elements of the high-frequency connection are embodied in the form of press-in pins on the side facing the circuit carrier.

In particular, by means of the last-mentioned feature it is ensured that a particularly simple electrical and mechanical means of forming contact between the high-frequency connection and the circuit board is made possible, which means promote large-series technical implementation.

In particular, the high-frequency connection serves to connect an antenna cable to the electronic controller, wherein the signal is to be passed on with minimum reflection losses to a receiver chip arranged on the circuit carrier (circuit board). For this purpose, it is necessary to optimize the transmission for transmitting ultra-high-frequency signals by minimizing the reflection.

In a first arrangement of the press-in pins provided according to the invention, the press-in pins are bent over through an angle of 90° from their original direction. Such an arrangement permits particularly simple mounting of the press-in pins with the circuit carrier. However, within the scope of the invention it is also possible, depending on the application case, in particular depending on the position or location of sensors on the circuit board, to bend over the press-in pins from their original direction though other angles, in particular with multiple angles of 45°.

An embodiment of the two elements of the high-frequency connection which is optimized with respect to the transmission properties can be achieved if the two elements are each embodied integrally and form a socket on the outside of the housing. The fact that the two elements are in one piece permits, in particular when viewed over the length of the transmission path, optimized cross sections and particularly good screening of the high-frequency conductor. Moreover, the embodiment as a socket makes it possible to use customary antenna connection cables which have a plug.

However, it is also possible that the two elements can be connected within the housing, on the side facing the outside of the housing, to an element which is separate from the two elements and which is preferably embodied as a socket.

In terms of manufacturing technology the two elements of the high-frequency connection can be embodied particularly easily and favorably as punched/bent parts.

Moreover, an embodiment is quite particularly preferred in which the high-frequency connection is encapsulated in certain areas by the material of the housing, embodied as an injection molded part, or of a connection body, which forms a pre-mold. Such an embodiment permits the high-frequency connection to the housing to be formed in a water-tight or medium-tight fashion, in particular without using additional sealing elements and with minimum expenditure on mounting.

A particularly simple geometry of the two elements of the high-frequency connection can be achieved if the two elements are arranged parallel to one another in the region of the press-in pins.

In a development of the last-mentioned concept in which the screen element has improved screening properties, there is provision that the screening element has two press-in pins between which a press-in pin of the high-frequency conductor is arranged.

Moreover, in order to improve the screening properties of the screening element it is advantageous if the screening element has at least one screening region which is widened with respect to the press-in pin of the high-frequency conductor and covers, at least in certain areas, the high-frequency conductor with respect to a direction which is arranged perpendicularly with respect to the screening region.

A further improved screening effect can be achieved if a plurality of screening regions are provided which form a preferably at least approximately enclosed receptacle space for the high-frequency conductor.

For this purpose, there may be provision, in particular, that the screening regions are arranged at a right angle to one another and are integrally connected to one another partially by curvature sections with a curvature radius.

### BRIEF DESCRIPTION OF THE DRAWINGS

Further advantages, features and details of the invention can be found in the following description of preferred exemplary embodiments and with reference to the drawings, in which:

FIG. 1 shows an electronic controller according to the invention in a perspective external view,

FIG. 2 shows a schematic illustration of a first embodiment of the invention using in each case one integral element for forming the high-frequency conductor and the screening element of a high frequency plug-type connection,

FIG. 3 shows an illustration corresponding to FIG. 2 in a second inventive embodiment of the high-frequency plug-type connection using an additional separate element for forming a socket,

FIG. 4 shows a perspective illustration of the high-frequency plug-type connection according to FIG. 3 in the region of a housing wall of the controller, and

FIGS. 5 to FIG. 7 each show a perspective illustration of differently embodied high-frequency conductors and screening elements for forming a high-frequency plug-type connection in the interior of the housing of the electronic controller.

Identical elements or elements with the same function are provided with the same reference numbers in the figures.

### DETAILED DESCRIPTION

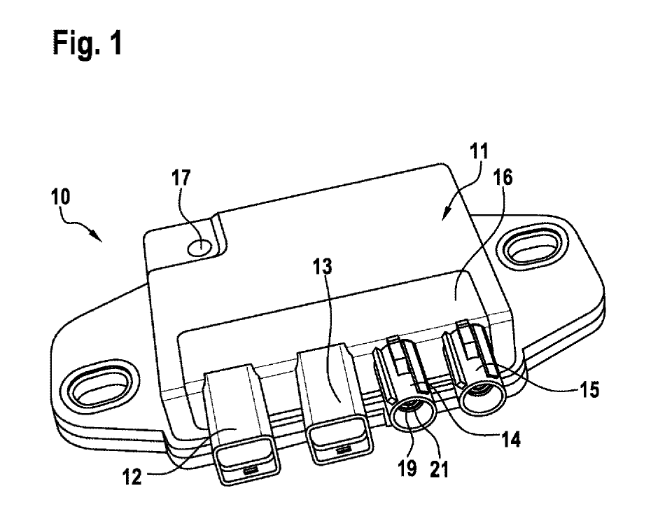

FIG. 1 illustrates an electronic controller 10 as a component of a driver assistance system, in particular of a navigation system, in a vehicle. The controller 10 is designed to calculate the position of the vehicle or of the controller 10 using satellite-assisted information and additionally using a sensor system, for example for sensing magnetic fields or accelerations or decelerations or pressures.

The housing 11, which is preferably composed of plastic and is manufactured using an injection molding method, of the controller 10 has, for the formation of electrical contact, for example two nano-MQS plug-type connections 12, 13 arranged one next to the other and two high-frequency connections 14, 15, also arranged one next to the other, which are each embodied in the form of a socket on the outside of the housing 11. Of course, the plug-type connections 12, 13 and the high-frequency connections 14, 15 can also have different positions on the housing 11. The two frequency connections 14, 15 permit a high-frequency antenna cable (not illustrated), which has a plug on the side facing the housing side, to be connected electrically to the housing 11 or the controller 10.

There can be provision for the plug-type connections 12, 13 and the high-frequency connections 14, 15 to be arranged within a connection body 16 which is composed of plastic, manufactured using an injection molding method and is inserted into an injection mold for manufacturing the housing 11, in such a way that the material of the housing 11 partially surrounds the material of the connection body 16 by virtue of the fact that the material of the housing 11 is applied by injection molding to the connection body 16. As a result, a medium-tight or water-tight arrangement and embodiment of the plug-type connections 12, 13 and of the high-frequency connections 14, 15 on the housing 11 is formed. In addition, a depression 17, in the region of which, for example, a diaphragm, which cannot be seen, of a pressure sensor is arranged, can be seen on the housing 11, on the upper side thereof.

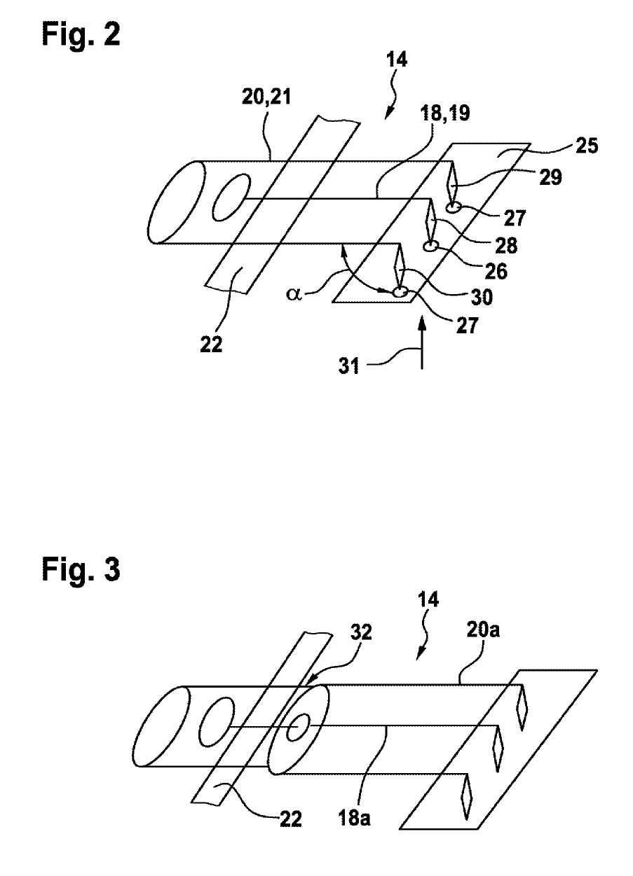

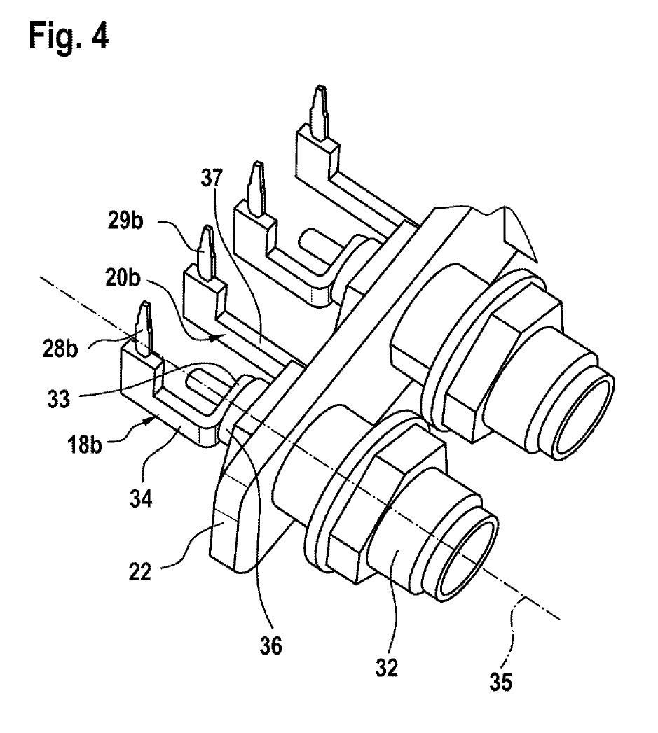

FIGS. 2 and 3 illustrate different arrangements or embodiments according to the invention using the example of one of the two high-frequency connections 14, 15, using the high-frequency connection 14 in the illustrated exemplary embodiment. In FIG. 2 it is apparent that a high-frequency connection 14 is composed basically of a first element 18 which forms a high-frequency conductor 19. The first element 18 or the high-frequency conductor 19 is at least partially surrounded by a second element 20 which forms a screening 21. This is apparent most clearly in FIG. 1, where the screening 21 surrounds the (pin-shaped) high-frequency conductor 19 in an annular shape on the outside of the housing 11.

In addition, it is apparent from FIG. 2 that the two elements 18, 20 penetrate a housing wall 22, which is a component of the housing 11 or of the connection body 16, and/or are inserted by injection molding by the material of the housing 11 or of the connection body 16. Furthermore apparent within the housing 11 of the controller 10 is a circuit carrier in the form of a circuit board 25 which has openings 26, 27 in the form of drilled holes which are designed to form electrical and mechanical contact between the circuit board 25 and the two elements 18, 20 of the high-frequency connection 14, 15. For this purpose, there is provision that the high-frequency conductor 19 has for example a press-in pin 28, and the screening 21 has two press-in pins 29, 30 which are bent over from their original direction through an angle α of 90° and are arranged perpendicularly with respect to the plane of the conductor plate 25.

The press-in direction of the circuit board 25 relative to the press-in pins 28 to 30 is denoted by the arrow 31. Additionally, it is to be noted that the scope of the invention also includes the fact that the press-in pins 29, 30 are embodied linearly with respect to the elements 18, 20, i.e. with an angle α of 180°. In the exemplary embodiment of the two elements 18, 20 which is illustrated in FIG. 2 it is essential that said elements 18, 20 are each embodied integrally.

FIG. 3 illustrates an embodiment of the invention which is modified compared to FIG. 2 and in which the two elements 18a, 20a are arranged, in contrast to the embodiment in FIG. 2, completely within the interior of the housing 11. In said embodiment the elements 18a, 20a are connected to a preferably standardized element 32 which penetrates the housing wall 22 and is embodied, for example, as a high-frequency socket which is known per se from the prior art.

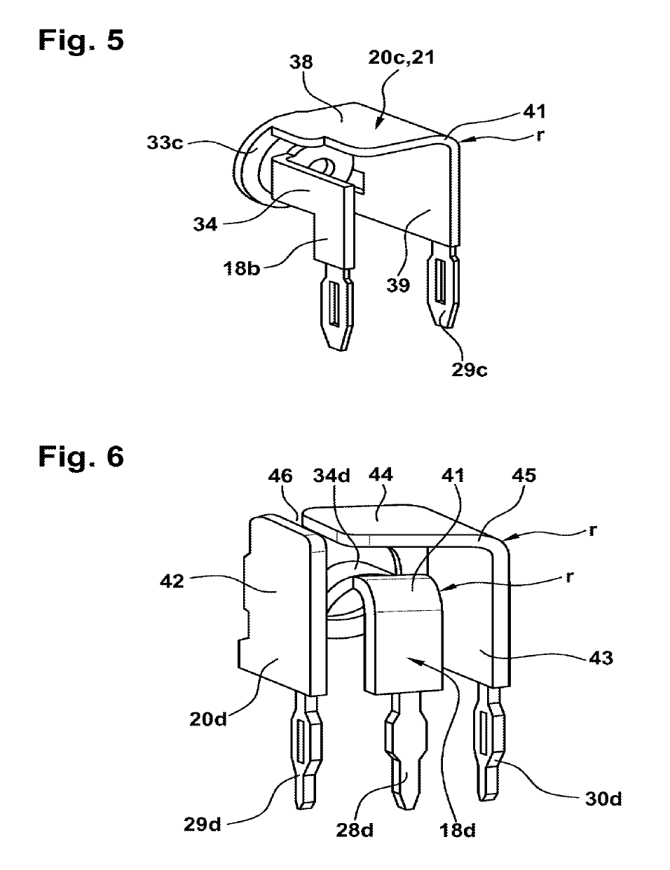

In accordance with the embodiment in FIG. 3, the illustration in FIG. 4 shows that the element 32 is connected in the region of the interior of the housing 11 to the two elements 18b, 20b. The two elements 18b, 20b are in this context embodied, in particular, as punched/bent parts made of sheet metal. The element 18b has an annular section 33 on which a transition section 34, integrally formed in a linear fashion, is integrally formed on one side, which transition section 34 runs parallel to a longitudinal axis 35 of the socket. The press-in pin 28b adjoins at a right angle to the transition section 34. The element 20b also has an annular section 36 which merges with a press-in pin 29b via a transition section 37 which is also arranged parallel to the longitudinal axis 35 of the socket. The two press-in pins 28b, 29b and the two transition sections 34 and 37 are arranged parallel to one another.

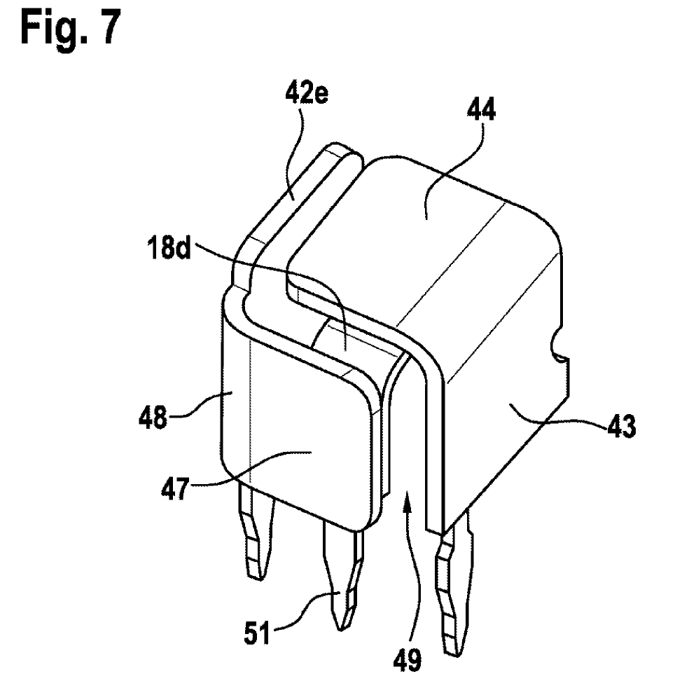

In FIG. 5, the element 18b is combined with a second element 20c which forms the screening 21 and which is modified with respect to the second element 20b, in accordance with FIG. 4, by virtue of the fact that the second element 20c has two rectangular screening regions 38, 39 which are connected to one another integrally via a curvature section 41 with a curvature radius r, wherein the two screening regions 38, 39 are arranged at a right angle to one another. While the one screening region 38 is connected to the annular section 33c, the press-in pin 29c protrudes from the other screening region 39, at the lower edge thereof. Furthermore, it is apparent that the transition section 34 of the first element 18b is arranged flush with the screening region 38 in a direction arranged perpendicularly with respect to the plane of the first screening region 38, or is covered by said screening region 38. The screening properties of the element 20c are improved compared to those of the element 20b in FIG. 4.

FIG. 6 illustrates an embodiment with screening properties which are improved further compared to FIG. 5 and in which the first element 18d has a transition section 34d which is arranged perpendicularly with respect to the press-in pin 28d and merges with the press-in pin 28d via a curvature section 41 which is provided with a radius r. The second element 20d has overall three screening regions 42 to 44 which are each approximately rectangular. The two screening regions 42 and 43, which each have a press-in pin 29d, 30d, are arranged parallel to one another in such a way that the first element 18d is arranged between the two screening regions 42, 43 or held thereby.

The screening region 44, which is connected integrally to the screening region 43 via a curvature section 45 with a curvature radius r, extends as far as the screening region 43 while preferably forming a minimum gap 46.

Finally, FIG. 7 illustrates a variant, modified with respect to FIG. 6, with further improved screening properties, in which variant the screening region 42e has an additional screening region 47 which is integrally formed on the screening region 42e and is arranged at a right angle to the screening region 42e via a curvature section 48 in such a way that the screening region 47 covers the first element 18d, wherein the screening regions 42e, 43, 44 and 47 form a receptacle region 49 in which the first element 18d is arranged. In addition, the first element 18d has a further press-in pin 51. The screening region 47 can also have an additional press-in pin (not illustrated).

For the case in which a plurality of screening regions 42, 42e, 43, 44 and 47 are connected to one another integrally via curvature radiuses r or curvature sections 41 it is advantageous to embody the curvature radiuses r or the curvature sections 41 in such a way that the screening regions 42, 42e, 43, 44 and 47 form an approximately round screening around the internal conductor or the first element 18b, 18d, with the result that the screening 21 and the first element 18b, 18d have the desired impedance.

The electronic controller 10 described in this respect can be redefined or modified in a variety of ways without departing from the concept of the invention.

1. An electronic controller (10) having a housing (11), having at least one high-frequency connection (14, 15), wherein the high-frequency connection (14, 15) has at least two elements (18; 18a; 18b; 18d, 20; 20a; 20b; 20c; 20d) which form a high-frequency conductor (19) for transmitting a high-frequency signal, and a screening element (21), wherein the at least two elements (18; 18a; 18b; 18d; 20; 20a; 20b; 20c; 20d) of the high-frequency connection (14, 15) are configured to be connected to a circuit carrier (25) in an interior of the housing (11), and wherein the at least two elements (18; 18a; 18b; 18d, 20; 20a; 20b; 20c; 20d) of the high-frequency connection (14, 15) are embodied in the form of press-in pins (28; 28b; 28d; 29; 29b; 29c; 29d, 51) on a side facing the circuit carrier (25).

2. The controller as claimed in claim 1, characterized in that the press-in pins (28; 28b; 28d; 29; 29b; 29c; 29d, 51) are bent over through an angle (α) of 90° from an original direction.

3. The controller as claimed in claim 1, characterized in that the press-in pins (28; 28b; 28d; 29; 29b; 29c; 29d, 51) are arranged in a contact-forming region with the circuit carrier (25) at a right angle to a plane of the circuit carrier (25).

4. The controller as claimed in claim 1, characterized in that the at least two elements (18, 20) are each embodied integrally and form a socket on an outside of the housing (11).

5. The controller as claimed in claim 1, characterized in that the at least two elements (18a; 18b; 18d; 20a; 20b; 20c; 20d) are configured to be connected within the housing (11), on a side facing an outside of the housing, to an element (32) which is separate from the at least two elements (18a; 18b; 18d; 20a; 20b; 20c; 20d).

6. The controller as claimed in claim 1, characterized in that the at least two elements (18; 18a; 18b; 18d; 20; 20a; 20b; 20c; 20d) of the high-frequency connection (14, 15) are embodied as punished/bent parts.

7. The controller as claimed in claim 1, characterized in that the high-frequency connection (14, 15) is encapsulated in certain areas by a material of the housing (11), embodied as an injection molded part, or of a connection body (16).

8. The controller as claimed in claim 1, characterized in that the at least two elements (18; 18a; 18b; 18d; 20; 20a; 20b; 20c; 20d) of the high-frequency connection (14, 15) are arranged parallel to one another in a region of the press-in pins (28; 28b; 28d; 29; 29b; 29c; 29d, 51).

9. The controller as claimed in claim 8, characterized in that the screening element (21) has two press-in pins (29d; 30d) between which a press-in pin (28d) of the high-frequency conductor (19) is arranged.

10. The controller as claimed in claim 9, characterized in that the screening element (21) has at least one screening region (38, 39, 42; 42e; 43, 44, 47) which is widened with respect to the press-in pin (28d) of the high-frequency conductor (19) and covers, at least in certain areas, the high-frequency conductor (19) with respect to a direction which is arranged perpendicularly with respect to the screening region (38, 39, 42; 42e, 43, 44, 47).

11. The controller as claimed in claim 10, characterized in that a plurality of screening regions (42e, 43, 44, 47) are provided, which plurality of screening regions form a receptacle space (49) for the high-frequency conductor (19).

12. The controller as claimed in claim 11, characterized in that the plurality of screening regions (38, 39, 42; 42e, 43, 44, 47) are arranged at a right angle to one another and are integrally connected to one another partially by curvature sections (41, 48) with a curvature radius (r).

13. The controller as claimed in claim 1, characterized in that the housing is composed of plastic.

14. The controller as claimed in claim 1, characterized in that the at least two elements (18a; 18b; 18d; 20a; 20b; 20c; 20d) are configured to be connected within the housing (11), on a side facing an outside of the housing, to an element (32) which is separate from the at least two elements (18a; 18b; 18d; 20a; 20b; 20c; 20d) and which is embodied as a socket.

15. The controller as claimed in claim 10, characterized in that a plurality of screening regions (42e, 43, 44, 47) are provided, which plurality of screening regions form an at least approximately enclosed receptacle space (49) for the high-frequency conductor (19).
